(19) United States
(12) Patent Application Publication
(10) Pub. No.: US 2010/0085732 A1
(43) Pub. Date: Apr. 8, 2010

(54) LIGHT SOURCE UNIT AND DISPLAY DEVICE

(75) Inventor: Kentaro Kamada, Kameyama-shi (JP)

Correspondence Address: SHARP KABUSHIKI KAISHA;C/O KEATING & BENNETT, LLP, 1800 Alexander Bell Drive, SUITE 200, Reston, VA, 20191, US

(73) Assignee: SHARP KABUSHIKI KAISHA, Osaka-shi, Osaka (JP)

(21) Appl. No.: 12/442,113

(22) PCT Filed: Jun. 28, 2007
(86) PCT No.: PCT/JP2007/063008

§ 371 Date: Mar. 20, 2009

(30) Foreign Application Priority Data
Nov. 7, 2006 (JP) 2006-301733

(51) Int. Cl. G02F 1/13357; F21V 3/00

(52) U.S. Cl. 362/97.1; 362/311.01; 362/311.04

(57) ABSTRACT

A light source unit prevents deterioration of display qualities, caused by “sagging” of a diffuser, and includes a diffuser and a light source, the diffuser being arranged above the light source, wherein the light source unit includes a light-shielding member covering a side surface of a corner of the diffuser, and preferably the light-shielding member covers an edge of an upper surface and a side surface of the diffuser, or the light-shielding member covers an edge of an upper surface of the optical sheet and further covers side surfaces of the diffuser and optical sheet.

### BACKGROUND OF THE INVENTION

1. Field of the Invention

The present invention relates to a light source unit and a display device. More particularly, the present invention relates to a light source unit suitable as a direct type backlight in a liquid crystal display device, and a display device.

2. Description of the Related Art

The light source unit is used, for example, in a display device including a non-self-emission display panel. In a liquid crystal display device, for example, a liquid crystal panel itself does not emit light. Therefore, a transmissive or semi-transmissive liquid crystal display device is provided with a backlight which causes light to enter a liquid crystal panel.

There are currently two different backlights used in a liquid crystal display device and the like: an edge light type (side light type) and a direct type. The direct type backlight has advantages in that it is suitably used in a large-sized display device and easily provides a high luminance. The liquid crystal display device currently has become dramatically larger because a process of using a larger mother glass has been completed, for example. Now the liquid crystal display device has established a position as a household television. In a television, brightness is an important basic performance characteristic. Therefore, a liquid crystal display device equipped with a large screen needs to include a large backlight which provides a high luminance, and therefore, such a liquid crystal display device has been increasingly provided with a direct type backlight.

According to structural characteristics of the direct type backlight, a plurality of light sources such as a cold cathode fluorescent lamp are provided on a back surface of a display panel such as a liquid crystal panel, and as a result, the direct type backlight has the following advantages. Many light sources can be arranged, thereby increasing a light amount; loss of light is small because light is caused to enter the display panel from the light sources without change in optical path; and the size of the display device can be easily increased. Further, in the direct type backlight, a diffuser or an optical sheet is generally arranged between the display panel and the light source in order to make uniform optical characteristics such as in-plane luminance.

The diffuser tends to sag or deform due to influences such as a difference in temperature between the light source side and the display panel side, the difference in temperature being generated by heat from the light source. Particularly in a large-sized display panel, the diffuser is also large, and therefore, the “sagging” of the diffuser is markedly caused. If the diffuser sags, light, which originally passes through an edge of the diffuser and enters the display panel, enters the display panel without passing through the diffuser. Therefore, uniformity of optical characteristics such as in-plane luminance is deteriorated.

In an attempt to solve this problem, Japanese Kokai Publication No. 2004-186080 and Japanese Kokai Publication No. 2004-327449 disclose that a supporting member which projects from the bottom surface side of a backlight is arranged in order to prevent the “sagging” and the like of a diffuser. Japanese Kokai Publication No. 2004-192912 discloses that a diffuser and a frame are integrally arranged. However, for example, in a liquid crystal display device for TV, which is getting larger, the deterioration of display qualities, caused by the “sagging” of the diffuser, particularly urgently needs to be prevented. In order to prevent the deterioration of display qualities more easily and effectively, the inventions disclosed in Japanese Kokai Publication No. 2004-186080, Japanese Kokai Publication No. 2004-327449, and Japanese Kokai Publication No. 2004-192912 still have room for improvement.

### SUMMARY OF THE INVENTION

In view of the above-described state of the art, preferred embodiments of the present invention provide a light source unit and a display device, each capable of preventing deterioration of display qualities, caused by “sagging” of the diffuser.

The present inventor made various investigations on a liquid crystal display device for TVs, which is getting larger. The inventor noted that particularly at a corner of a display region, display qualities are markedly deteriorated. As such deterioration of display qualities, a phenomenon in which a white portion is observed at four corners of the display region at the time of black state is mentioned. Then, the inventor discovered the following. Particularly in the case that a large-sized display panel is used, the “sagging” of the diffuser is markedly generated at corners of the display region, which causes light leakage at the corners of the diffuser. Therefore, the display qualities are deteriorated. This deterioration of display qualities, due to the “sagging” of the diffuser, can be effectively prevented by arranging a light-shielding member to cover a side surface of the corners of the diffuser. As a result, the above-mentioned problems have been admirably solved, leading to development and completion of preferred embodiments of the present invention.

A preferred embodiment of the present invention provides a light source unit including a diffuser and a light source, the diffuser being arranged above the light source, wherein the light source unit includes a light-shielding member covering a side surface of a corner of the diffuser.

According to the light source unit of a preferred embodiment of the present invention, a diffuser is arranged above the light sources. The light sources are not especially limited, and examples thereof include a dot light source and a linear light source. A light-emitting diode (LED) is mentioned as the dot light source, for example. A cold cathode fluorescent lamp and a hot cathode fluorescent lamp are mentioned as the linear light source, for example. Further, the shape, material, size, and the like of the diffuser are not especially limited as long as it has a function of diffusing light incident from the light sources.

The above-mentioned light source unit includes a light-shielding member covering a side surface of the corners of the diffuser. FIG. 7 is a planar perspective view of a commonly used light source unit. FIG. 8 is a cross-sectional schematic view of the light source unit taken along dashed line X-Y in FIG. 7. As shown in FIG. 8, the light source unit generally has a structure in which light sources 1, a diffuser 37, and a display panel 14 are stacked in this order from the bottom, within a frame 12. If such a light source unit is used for a certain period, “sagging” of the diffuser 37 is generated by heat from the light sources 1, as shown in FIG. 8. This “sagging” causes light leakage at corners of the diffuser 37, resulting in deterioration of display qualities.

The light-shielding member according to a preferred embodiment of the present invention is arranged in order to shield the leakage light generated by the “sagging” of the diffuser. The light-shielding member preferably covers at least corners of the diffuser where the “sagging” is most markedly observed. If the diffuser 37 has a rectangular main surface, as shown in FIG. 7, for example, the light-shielding member is arranged to cover four corners 13a, 13b, 13c, and 13d of the diffuser 37. Thus, according to the light source unit of a preferred embodiment of the present invention, the light-shielding member covers the corners of the diffuser. Therefore, even if the diffuser sags, the light leakage generated at corners of the display region can be minimized and prevented, and as a result, the deterioration of display qualities can be prevented.

The above-mentioned light-shielding member preferably covers at least a side surface of the corners of the diffuser. If the light-shielding member is in contact with the side surface of the diffuser to cover the diffuser, the light leakage at the corners of the diffuser can be directly prevented. It is preferable that the above-mentioned light-shielding member is larger than an area of the side surface of the diffuser. It is more preferable that in the thickness direction of the diffuser, the light-shielding member is larger than a sum of the thickness of the diffuser and a warpage amount of the diffuser. The warpage amount used herein means an amount of a change in shape in the thickness direction between the diffuser before the change and that after the change.

The diffuser sags more on the short sides than on the long sides. Therefore, the light-shielding member is preferably arranged on the short sides of the diffuser. It is more preferable that the light-shielding member is arranged on both of the short and long sides. That is, it is preferable that the light-shielding member covers the entire outer edge of the diffuser. According to such a preferred embodiment in which the light-shielding member is arranged to cover the entire outer edge of the diffuser, the light leakage caused by the “sagging” of the diffuser can be more reliably prevented and minimized. As a result, the deterioration of display qualities can be effectively prevented. The light-shielding member used herein preferably is a member whose light-shielding ratio for light (visible light) having a wavelength of about 380 nm to about 780 nm is about 80% or more, and preferably is a member whose reflectance for the light is about 80% or more, for example.

The configuration of the light source unit according to preferred embodiments of the present invention is not especially limited as long as it essentially includes the above-mentioned light source, diffuser, and light-shielding member. The light source unit may or may not include other components.

The following preferred embodiments of the light source unit of the present invention are described. A first preferred embodiment in which the light-shielding member covers an edge of an upper surface and a side surface of the diffuser; a second preferred embodiment in which the light source unit includes an optical sheet on the diffuser, and the light-shielding member covers an edge of an upper surface of the optical sheet and further covers side surfaces of the diffuser and optical sheet. According to the first preferred embodiment or the second preferred embodiment, a complicated structure for fixing the light-shielding member is not needed. Therefore, the light source unit having a simple structure is enough to effectively prevent the deterioration of display qualities, caused by the “sagging” of the diffuser. According to the second preferred embodiment, the light-shielding member can prevent the “sagging” of the optical sheet, caused by heat, or prevent deterioration of display qualities, caused by the “sagging” of the optical sheet. According to the first and second preferred embodiments, a light-shielding member having an L-shaped cross section is preferably used. According to the second preferred embodiment, the number of the optical sheets arranged on the diffuser is not especially limited. If a plurality of optical sheets are arranged on the diffuser, it is preferable that the light-shielding member covers an edge of an upper surface of the top optical sheet and side surfaces of the diffuser and all of the optical sheets. The optical sheet used herein is not especially limited as long as it is a sheet which changes light characteristics, such as a prism sheet (lens sheet), a diffusion sheet, and a polarization reflective sheet, for example.

It is preferable that the diffuser is made of polycarbonate or a methyl methacrylate-styrene copolymer, for example. If polycarbonate (PC) or a methyl methacrylate-styrene copolymer (MS) is used for the diffuser, a diffuser excellent in light transmittance, durability, and lightweight property can be obtained.

It is preferable that the diffuser has a lens structure. Optical sheets such as a diffusion sheet, a lens sheet, and a polarization sheet, for changing characteristics of light which has passed through the diffuser are generally arranged on the diffuser. The diffuser in the present preferred embodiment is prepared by providing a diffuser with lens functions which such an optical sheet and the like has. For example, a preferred embodiment in which a common diffuser is provided with a lenticular lens to have an integrated structure is mentioned. In this preferred embodiment, a lens portion of the diffuser can be prevented from sagging due to heat, and as a result, the diffuser functions and the lens functions can be consolidated and the effect of improving the luminance can be obtained.

It is preferable that the light-shielding member is made of polycarbonate, acrylic resin, or polypropylene, for example. The light-shielding member in the light source unit according to a preferred embodiment of the present invention is not especially limited, as mentioned above, as long as the shielding member is a member whose light-shielding ratio for light (visible light) having a wavelength of about 380 nm to about 780 nm is about 80% or more and preferably a member whose reflectance for the light is about 80% or more, for example. Among these, a light-shielding member made of polycarbonate, acrylic resin, or polypropylene is preferably used, for example. These materials become white if they are each mixed with a reflective material. The reflectance can be arbitrarily changed in accordance with a concentration of the reflective material. Use of these materials makes it possible to prepare a light-shielding member that is excellent in durability and lightweight property.

Another preferred embodiment of the present invention provides a display device including the light source unit. The display device according to a preferred embodiment of the present invention includes the light source unit where the light-shielding member covering the side surface of the corners of the diffuser is arranged. Therefore, the deterioration of display qualities, caused by the “sagging” of the diffuser, can be effectively prevented. As a result, the display device can exhibit excellent display qualities. A display device including a non-self-emission display panel is mentioned as the above-mentioned display device. For example, a liquid crystal display device including the liquid crystal panel is preferable. That is, the light source unit of a preferred embodiment of the present invention is preferably used as an illumination device for display devices, and particularly preferably used as a direct type backlight for liquid crystal display devices. It is preferable that the display device constitutes a television receiver. The display device according to a preferred embodiment of the present invention includes the direct type light source unit where the diffuser is arranged above the light sources. Therefore, the display device is suitable for a television receiver which needs to be increased in size.

The light source unit according to a preferred embodiment of the present invention includes a light-shielding member covering the side surface of the corners of the diffuser, and therefore, the deterioration of display qualities, caused by the “sagging” of the diffuser, can be effectively prevented.

Other features, elements, steps, characteristics and advantages of the present invention will become more apparent from the following detailed description of preferred embodiments of the present invention with reference to the attached drawings.

### BRIEF DESCRIPTION OF THE DRAWINGS

FIG. 1-1 is a perspective exploded view schematically showing the configuration of the direct type liquid crystal display device in accordance with Preferred Embodiment 1 of the present invention.

FIG. 1-2 is a cross-sectional view schematically showing the configuration of the direct type liquid crystal display device in accordance with Preferred Embodiment 1, as viewed in the direction perpendicular to the longitudinal direction of the linear light source.

FIGS. 2A and 2B are views schematically showing the method of holding linear light sources in the direct type liquid crystal display device in accordance with Preferred Embodiment 1, wherein FIG. 2A is an enlarged perspective view of the light source-holding member, and FIG. 2B is a planar view showing arrangement of the light source-holding member.

FIGS. 3A and 3B are perspective views schematically showing the arrangement relationship among the diffuser, the optical sheet, and the light-shielding member in the backlight in accordance with Preferred Embodiment 1, wherein FIG. 3A is an enlarged view of the light-shielding member, and FIG. 3B is an overall view showing the arrangement of the light-shielding member and the diffuser.

FIGS. 4A and 4B are perspective views schematically showing the arrangement relationship of the diffuser and the light-shielding member in the backlight in accordance with Preferred Embodiment 2 of the present invention, wherein FIG. 4A is an enlarged view of the light-shielding member, and FIG. 4B is an overall view showing the arrangement of the light-shielding member and the diffuser.

FIGS. 5A and 5B are perspective views schematically showing the arrangement relationship of the diffuser and the light-shielding member in the backlight in accordance with Preferred Embodiment 3, wherein FIG. 5A is an enlarged view of the light-shielding member, and FIG. 5B is an overall view showing the arrangement of the light-shielding member and the diffuser.

FIGS. 6A and 6B are perspective views schematically showing the arrangement relationship among the diffuser, the optical sheet, and the light-shielding member in the backlight in accordance with Preferred Embodiment 4, wherein FIG. 6A is an enlarged view of the light-shielding member, and FIG. 6B is an overall view showing the arrangement of the light-shielding member and the diffuser.

FIG. 7 is a planar perspective view of the commonly used light source unit.

FIG. 8 is a schematic cross-sectional view of the light source unit taken along dashed line X-Y in FIG. 7.

### DETAILED DESCRIPTION OF THE PREFERRED EMBODIMENTS

The present invention is described in more detail below with reference to preferred embodiments illustrated in the drawings, but not limited to only these preferred embodiments.

### Preferred Embodiment 1

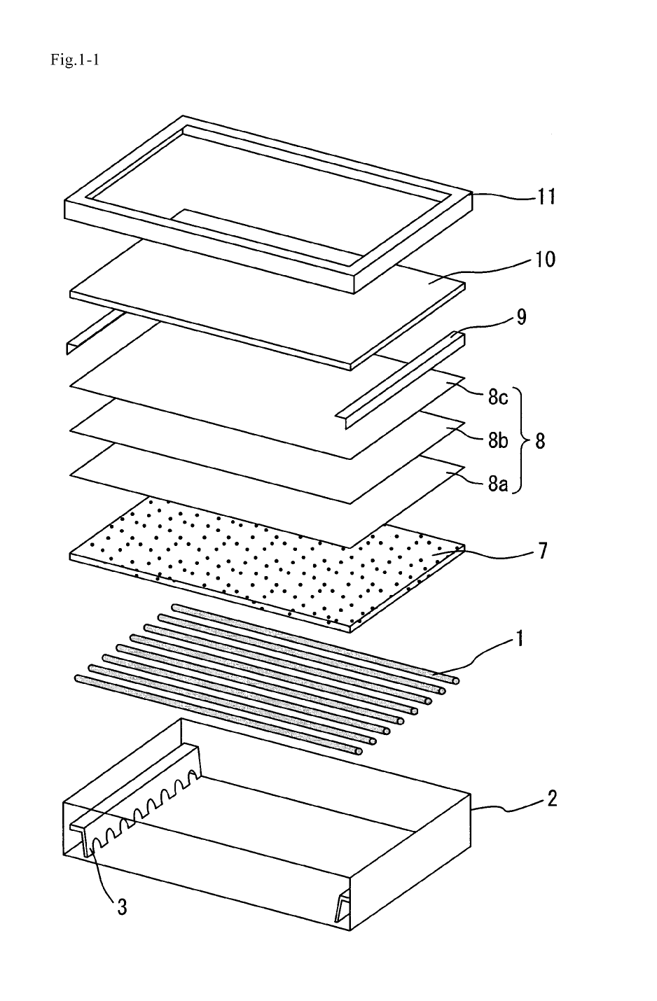

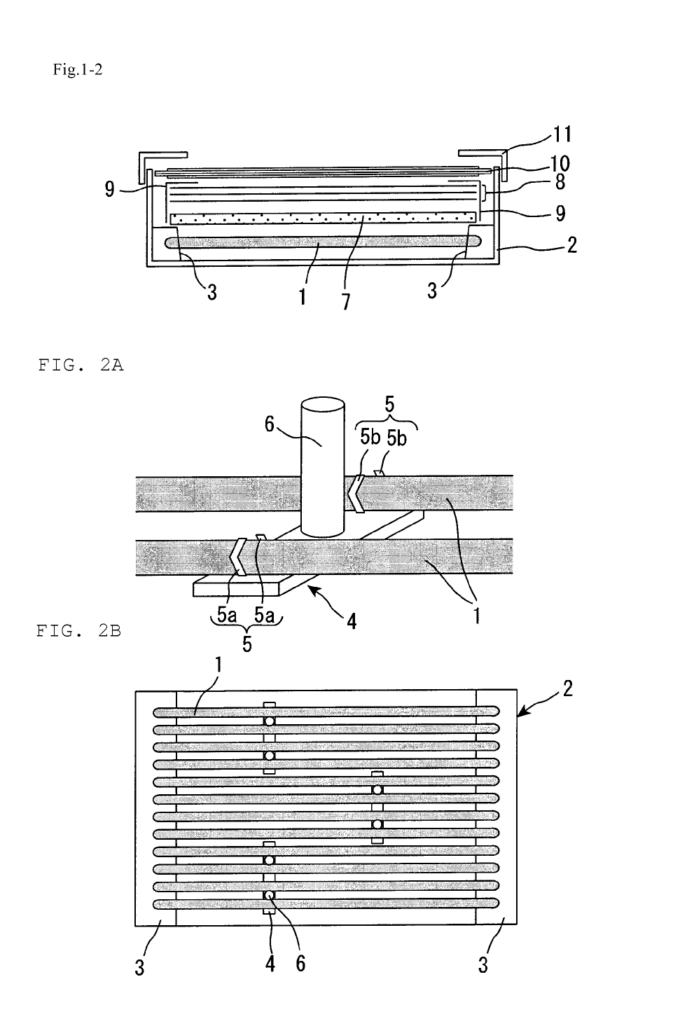

A direct type backlight for liquid crystal display devices, in accordance with preferred embodiments the present invention, is mentioned with reference to drawings. FIG. 1-1 is a perspective exploded view schematically showing a configuration of a liquid crystal display device in accordance with Preferred Embodiment 1. FIG. 1-2 is a cross-sectional view schematically showing the configuration of the liquid crystal display device in accordance with Preferred Embodiment 1, as viewed in the direction perpendicular to the longitudinal direction of a linear light source.

The liquid crystal display device in Preferred Embodiment 1 has a configuration in which a lower frame 2, linear light sources 1, a diffuser 7, optical sheets 8, a light-shielding member 9, a liquid crystal panel 10, and an upper frame 11 are stacked as shown in FIGS. 1-1 and 1-2.

### Lower Frame and Linear Light Source

The lower frame 2 is a box casing whose top is an opening. On the short sides of the inner periphery of the lower frame 2, the plastic frame 3 supporting the diffuser 7 is arranged. Inside the lower frame 2, a plurality of the linear light sources (lamps) 1 are arranged in parallel or substantially parallel to each other, and both ends of the light sources 1 are within the plastic frame 3. A reflective member is placed on the bottom of the lower frame 2 to reflect light from the linear light sources 1, and thereby the usage efficiency of light from the linear light sources 1 can be improved. Metals such as aluminum and stainless are preferably used as a material for the lower frame 2 in view of heat releasing property, mechanical strength, shape stability, lightweight property, and costs. A cold cathode fluorescent lamp is preferably used as the linear light sources 1.

FIGS. 2A and 2B are views schematically showing a method of holding the linear light sources 1 in the liquid crystal display device in accordance with Preferred Embodiment 1. FIG. 2A is an enlarged perspective view of a light source-holding member 4. FIG. 2B is a planar view showing arrangement of the light source-holding member 4. As shown in FIGS. 2A and 2B, one light source-holding member 4 preferably includes four light source-gripping portions 5, for example, arranged at regular intervals and two supporting pins 6. A pair of the light source-gripping portions 5 defines a structure of gripping the linear light source 1 and fixes a position of the linear light source 1. The supporting pin 6 supports the diffuser 7 from below. The supporting pin 6 is arranged between the first light source-gripping portion 5a and the second light source-gripping portion 5b, and between the third light source-gripping portion and the fourth light source-gripping portion when the four light source-gripping portions 5 provided for one light source-holding member 4 are defined as the first light source-gripping portion 5a, the second light source-gripping portion 5b, the third light source-gripping portion, and the fourth light source-gripping portion.

### Diffuser, Optical Sheet, and Shielding Member

Above the lower frame 2, the diffuser 7 is arranged to cover the opening of the lower frame 2. Thus, by arranging the diffuser 7 above the light sources 1, an image of the light sources 1 can be eliminated. As a result, uniform in-plane light can be obtained. The diffuser 7 also serves as a base on which the below-mentioned optical sheets 8 are placed. The diffuser 7 is supported by the plastic frame 3 within the lower frame 2, and also by the supporting pin 6 provided for the light source-holding member 4.

The diffuser 7 is a plate member having a substantially uniform thickness. The thickness of the diffuser 7 is preferably about 0.5 mm or more and about 4 mm or less, and more preferably, about 2 mm or more and about 3 mm or less, for example. If the thickness of the diffuser 7 is too large, high costs, an increase in product weight, a reduction in luminance, and yellowing of emitted light, and the like, might be caused. If the thickness of the diffuser 7 is too small, uniformity of emission light becomes difficult to secure. Further, a variation in thickness directly leads to a variation in uniformity of emission light or in luminance. Therefore, product qualities become difficult to make uniform.

Examples of a material for the diffuser 7 include polycarbonate (PC), methyl methacrylate-styrene copolymer (MS), polymethylmethacrylate (PMMA), cycloolefins, and glass. Among these, polycarbonate, methyl methacrylate-styrene copolymer are preferably used. Each of the total light transmittance and a diffusion transmittance of the diffuser 7 is preferably about 20% to about 80% and more preferably about 40% to about 65%, for example. If the total light transmittance and the diffusion transmittance of the diffuser 7 are too large, the uniformity of the emission light maybe difficult to secure. If they are too small, the luminance of the emission light cannot be secured, which possibly results in a reduction in light emission efficiency.

The optical sheets 8 are arranged on the diffuser 7. The optical sheets 8 change characteristics of light which has passed through the diffuser 7. If necessary, one or more optical sheets such as a diffusion sheet, a lens sheet, and a polarization sheet, and the like, are appropriately used. According to Preferred Embodiment 1, three optical sheets 8 such as a lower diffusion sheet 8a, a prism sheet (lens sheet) 8b, and an upper diffusion sheet 8c are arranged in this order from the light sources 1 side, for example. A preferred embodiment in which a polarization reflective sheet is arranged instead of the upper diffusion sheet 8c is also preferably provided. Polyethylene terephthalate (PET), polycarbonate, and the like, are mentioned as a material for the diffusion sheet 8a. Examples of a material for the prism sheet 8b include UV curable resins such as an acrylic resin and materials prepared by mixing polyethylene terephthalate with UV curable resins such as an acrylic resin.

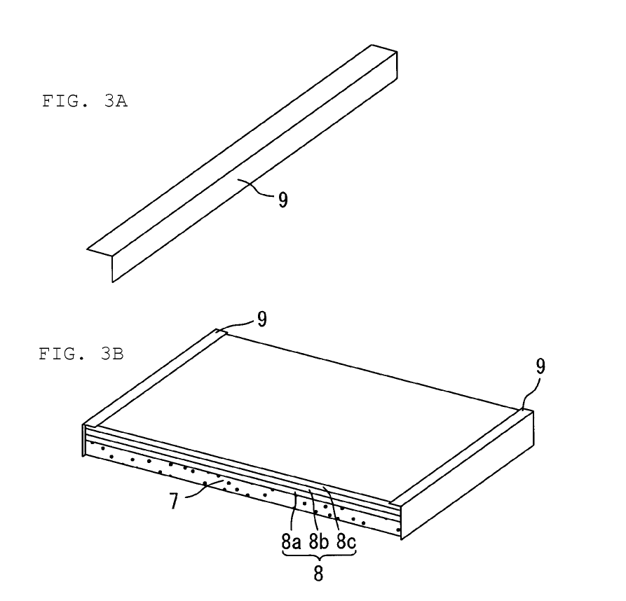

The light-shielding member 9 is arranged on the short sides of the rectangular optical sheets 8. FIGS. 3A and 3B are perspective views schematically showing an arrangement relationship among the diffuser 7, the optical sheets 8, and the light-shielding member 9 in the backlight in accordance with Preferred Embodiment 1. As shown in FIG. 3A, the light-shielding member 9 preferably is long and thin, and has an L-shaped cross section. As shown in FIG. 3B, the light-shielding member 9 is arranged to cover an edge of an upper surface of the optical sheet 8 and side surfaces of the diffuser 7 and the optical sheets 8. According to Preferred Embodiment 1, the light-shielding member 9 is arranged only on the short sides of the optical sheet 8. However, it is preferable that the light-shielding member 9 is arranged also on the long sides of the optical sheet 8 in order to more sufficiently prevent the deterioration of display qualities (Preferred Embodiment 4). The light-shielding member 9 in Preferred Embodiment 1 covers an edge of the upper surface of the optical sheet 8. This means that the light-shielding member 9 also has a function of holding the optical sheets 8 and stabilizing the position of the optical sheets 8. As the diffuser 7 in Preferred Embodiment 1, a diffuser having a lens structure may be used, and in such a case, the optical sheet 8 may be further placed on such a diffuser.

The material for the light-shielding member 9 is not especially limited. The light-shielding member 9 may be made of a light-shielding material. Further, a member whose surface is provided with a light-shielding treatment may be used as the light-shielding member 9. As the light-shielding treatment, for example, a coating of a light-shielding coating material, formation of a metal thin film by deposition and the like, attachment of a light-shielding tape, and the like, may be used. Opalescent polycarbonate, opalescent acrylic resin, opalescent polypropylene, and the like, may be preferably used as such a light-shielding material. With regard to the light-shielding member 9 according to a preferred embodiment of the present invention, only a portion of the light-shielding member 9 may have a light-shielding property. For example, the light-shielding member 9 may be integrated with the optical sheet 8.

The size of the light-shielding member 9 is appropriately determined in accordance with the warpage amount of the diffuser 7. The warpage amount of the diffuser 7 varies depending on the size or material (linear expansion coefficient) of the diffuser 7, use conditions, and the like. The following Table 1 shows measurement results of a warpage amount of the diffuser 7 which is made of polycarbonate and preferably has a thickness of about 2 mm or about 3 mm, for example, when the liquid crystal display device in Preferred Embodiment 1 is used under actual use conditions (for one hour after turning power on). The screen size in Table 1 is expressed as a length (inch) of a diagonal line of a display screen in the liquid crystal display device. The length is almost the same as a length of a diagonal line of the diffuser 7.

As shown in Table 1, the warpage amount is about 2 cm to about 4 cm, for example. Accordingly, in this case, it is preferable that a length in the thickness direction of the light-shielding member 9 at a portion in contact with the side surface side of the diffuser 7 is longer than a sum of the warpage amount of the diffuser 7 and the thickness of the diffuser 7 so that the deterioration of display qualities, caused by the “sagging” of the diffuser 7, can be sufficiently prevented. Further, it is optimal to set a length in the in-plane direction of the light-shielding member 9 at a portion in contact with the upper surface side of the diffuser 7 to be as long as possible, unless the light-shielding member 9 extends to an active display region.

TABLE 1

| | | Thickness of | Warpage | Length in thickness direction | Length in in-plane direction at |
|---|---|---|---|---|---|
| | | diffuser | amount | at a part in contact with a side | a part in contact with an upper |
| Screen size | Material | [mm] | [cm] | surface of diffuser [cm] | surface of diffuser [mm] |
| 65-inch | PC | 3 | 4 | 4.3 | 10 |
| 45-inch | PC | 2 | 3 | 3.2 | 10 |
| 37-inch | MS | 2 | 2 | 2.2 | 8 |
| 32-inch | MS | 2 | 2 | 2.2 | 6 |

### Liquid Crystal Panel and Upper Frame

The liquid crystal panel 10 is arranged above the optical sheets 8 and the light-shielding member 9. The liquid crystal panel 10 has a configuration in which a liquid crystal layer is interposed between glass substrates, and a retardation film, a polarizer, and the like, are each attached to glass substrate surfaces on the side opposite to the liquid crystal layer side. In addition, the upper frame 11 is fitted with the lower frame 2 from the display surface side of the liquid crystal panel 10. Examples of a preferable material for the upper frame 11 include a resin or a metal such as aluminum and stainless.

In such a manner, the liquid crystal display device in Preferred Embodiment 1 is completed.

The liquid crystal display device in Preferred Embodiment 1 can provide display with display qualities whose deterioration is sufficiently prevented because light leakage at corners of the diffuser is suppressed.

### Preferred Embodiment 2

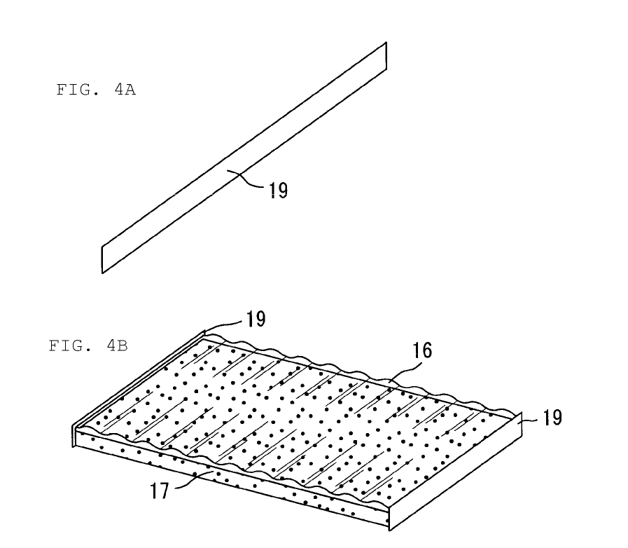

FIGS. 4A and 4B are perspective views schematically showing an arrangement relationship of a diffuser 17 and a light-shielding member 19 in a backlight in accordance with Preferred Embodiment 2. As shown in FIG. 4A, the light-shielding member 19 has a rectangular shape. As shown in FIG. 4B, the light-shielding member 19 is arranged to cover a side surface of the diffuser 17. According to Preferred Embodiment 2, only on the short sides of the diffuser 17, the light-shielding member 19 is arranged. However, it is preferable that the light-shielding member 19 is arranged also on the long sides of the diffuser 17 in order to more sufficiently prevent the deterioration of display qualities (Preferred Embodiment 3). According to the diffuser 17 in accordance with Preferred Embodiment 2, a lenticular lens 16 is arranged on the diffuser 17 surface to be integrated with the diffuser 17. Optical sheets may be further placed on the diffuser 17.

The liquid crystal display device in Preferred Embodiment 2 has the same configuration as in Preferred Embodiment 1, except for the diffuser 17 and the light-shielding member 19. Such a liquid crystal display device in Preferred Embodiment 2 can provide display with display qualities whose deterioration is sufficiently prevented because light leakage at corners of the diffuser 17 is prevented and minimized.

### Preferred Embodiment 3

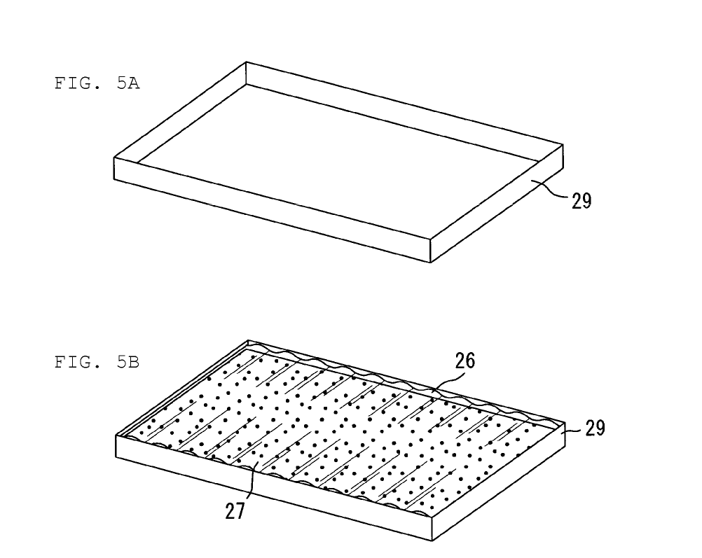

FIGS. 5A and 5B are perspective views schematically showing an arrangement relationship of a diffuser 27 and a light-shielding member 29 in a backlight in accordance with Preferred Embodiment 3. The light-shielding member 29 has a shape that follows side surfaces of a rectangular parallelepiped, as shown in FIG. 5A. The light-shielding member 29 is arranged to cover a side surface of the diffuser 27, as shown in FIG. 5B. According to Preferred Embodiment 3, the light-shielding member 29 is arranged not only on the short sides but also on the long sides of the diffuser 27. Therefore, the entire outer edge of the diffuser 27 can be covered, and therefore the deterioration of display qualities can be more sufficiently prevented. According to the diffuser 27 in accordance with Preferred Embodiment 3, a lenticular lens 26 is arranged on the diffuser 27 surface to be integrated with the diffuser 27 therewith. Optical sheets may be further placed on the diffuser 27.

The liquid crystal display device in accordance with Preferred Embodiment 3 has the same configuration as in Preferred Embodiment 1, except for the diffuser 27 and the light-shielding member 29. Such a liquid crystal display device in Preferred Embodiment 3 can provide display with display qualities whose deterioration is sufficiently prevented because light leakage at corners of the diffuser 27 can be prevented and minimized.

### Preferred Embodiment 4

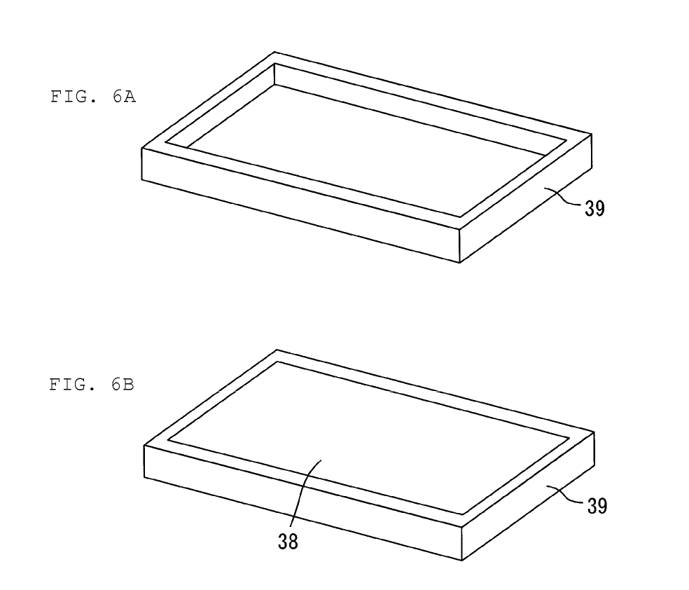

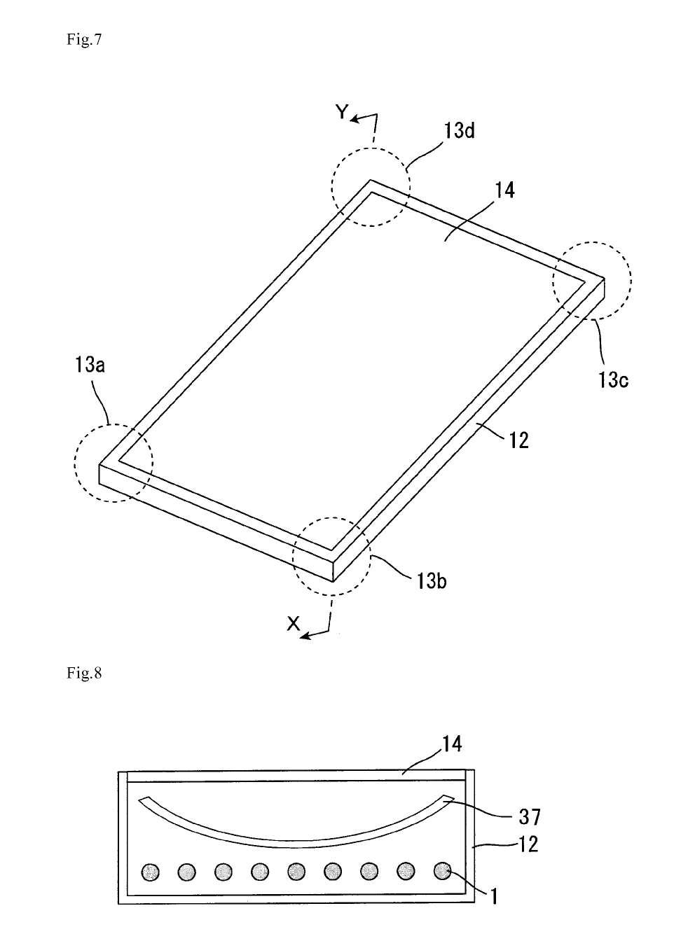

FIGS. 6A and 6B are a planar view schematically showing an arrangement relationship among a diffuser, an optical sheet 38, and a light-shielding member 39 in a backlight in accordance with Preferred Embodiment 4. The diffuser is arranged below the optical sheet 38 and entirely covered with the light-shielding member 39. The light-shielding member 39 is long and thin, and has an L-shaped cross section, as shown in FIG. 6A. The light-shielding member 39 is arranged to cover an edge of upper surfaces and side surfaces of the diffuser and the optical sheet 38, as shown in FIG. 6B. According to Preferred Embodiment 4, the light-shielding member 39 is arranged not only on the short sides but also on the long sides of the diffuser and the optical sheet 38. Therefore, the light-shielding member 39 covers the entire outer edge of the diffuser and the optical sheet 38. Therefore, the deterioration of display qualities can be more sufficiently prevented. The light-shielding member 39 in Preferred Embodiment 4 covers an edge of the upper surface of the optical sheet 38. This means that the light-shielding member 39 also has a function of holding the optical sheet 38 and stabilizing a position of the optical sheet 38. As the diffuser in Preferred Embodiment 4, a diffuser having a lens structure may be used, and in such a case, the optical sheet may be further placed on such a diffuser.

The liquid crystal display device in Preferred Embodiment 4 has the same configuration as in Preferred Embodiment 1, except for the diffuser and the light-shielding member 39. The liquid crystal display device in Preferred Embodiment 4 can provide display with display qualities whose deterioration is sufficiently prevented because light leakage at corners of the diffuser is prevented and minimized.

The present application claims priority under the Paris Convention and the domestic law in the country to be entered into national phase on Patent Application No. 2006-301733 filed in Japan on Nov. 7, 2006, the entire contents of which are hereby incorporated by reference.

The terms “or more” and “or less” in the present description mean that the value described (boundary value) is included.

While preferred embodiments of the present invention have been described above, it is to be understood that variations and modifications will be apparent to those skilled in the art without departing the scope and spirit of the present invention. The scope of the present invention, therefore, is to be determined solely by the following claims.

1-9. (canceled)

10. A light source unit comprising:
a light source;
a diffuser arranged above the light source; wherein
the light source unit includes a light-shielding member arranged to cover a side surface of a corner of the diffuser.

11. The light source unit according to claim 10, wherein the light-shielding member is arranged to cover an entire outer edge of the diffuser.

12. The light source unit according to claim 10, wherein the light-shielding member is arranged to cover an edge of an upper surface and a side surface of the diffuser.

13. The light source unit according to claim 10, wherein the light source unit includes an optical sheet on the diffuser, and
the light-shielding member is arranged to cover an edge of an upper surface of the optical sheet and is arranged to cover side surfaces of the diffuser and optical sheet.

14. The light source unit according to claim 10, wherein the diffuser is made of polycarbonate or a methyl methacrylate-styrene copolymer.

15. The light source unit according to claim 10, wherein the diffuser has a lens structure.

16. The light source unit according to claim 10, wherein the light-shielding member is made of polycarbonate, acrylic resin, or polypropylene.

17. A display device comprising the light source unit according to claim 10.

18. A television receiver comprising the display device according to claim 17.
